(19) United States
(12) Patent Application Publication
(10) Pub. No.: US 2024/0303433 A1
(43) Pub. Date: Sep. 12, 2024

(54) INFORMATION PROCESSING APPARATUS, SYSTEM, METHOD, AND NON-TRANSITORY COMPUTER READABLE MEDIUM IN WHICH PROGRAM IS STORED

(71) Applicant: NEC Platforms, Ltd., Kawasaki-shi, Kanagawa (JP)

(72) Inventor: Kazuki Nakajima, Kanagawa (JP)

(73) Assignee: NEC Platforms, Ltd., Kawasaki-shi, Kanagawa (JP)

(21) Appl. No.: 18/269,177

(22) PCT Filed: Oct. 8, 2021
(86) PCT No.: PCT/JP2021/037357

§ 371 Date: Jun. 22, 2023

(30) Foreign Application Priority Data
Dec. 25, 2020 (JP) 2020-217153

(51) Int. Cl. G06F 40/216

(52) U.S. Cl. CPC G06F 40/216

(57) ABSTRACT

An information processing apparatus includes: an input unit configured to input a menu name of a restaurant; an output unit configured to output a category name; a storage unit configured to store the menu name and the category name corresponding to the menu name so as to be associated with each other; a morphological analysis unit configured to execute morphological analysis to divide the inputted menu name into words and determine parts of speech; and a specification unit configured to generate, in a case where no category name corresponding to the inputted menu name is stored, a feature amount vector characterizing whether each of the words is included in the menu name or not as a result of the morphological analysis, and specify a category name corresponding to the inputted menu name based on a result of learning the menu name and the category name.

### TECHNICAL FIELD

The present disclosure relates to an information processing apparatus, system, method and program.

### BACKGROUND ART

In order to classify texts into certain unified categories, a method of executing natural language processing in which morphological analysis and artificial intelligence are combined has often been used. The morphological analysis is a technique in which a meaning indicated by a piece of writing is analyzed by determining each part of speech or extracting dependencies between parts of speech after decomposing words structured as the piece of writing into the smallest units to divide the piece of writing. The artificial intelligence is a technique in which by learning a large number of pairs of texts and categories into which the texts are to be classified, a relationship hidden between them is extracted for each category and human intellectual judgment criteria are reproduced artificially.

Now, when a restaurant (or an eating place) considers how to increase its own sales, it is necessary to refer to which category of menu is sold well at other restaurants. Therefore, a method of using combination of morphological analysis and artificial intelligence in category classification of restaurant menus is conceivable. However, it is possible to execute basic analyzation for a part of speech, a basic structure, and the like of a piece of writing by executing morphological analysis, but it is difficult to highly analyze the piece of writing. Patent Literature 1 discloses a technique regarding a method of executing category classification of restaurant menus. Further, Patent Literature 2 discloses a technique for excluding words that are not suitable to express features of a document by morphological analysis to improve accuracy of calculating a degree of similarity between two documents.

### CITATION LIST

### Patent Literature

Patent Literature 1: Japanese Unexamined Patent Application Publication No. 2012-234368
Patent Literature 2: Japanese Unexamined Patent Application Publication No. H11-134359

### SUMMARY OF INVENTION

### Technical Problem

In executing category classification of restaurant menus, in order to trust a classification result by artificial intelligence, it is necessary that an accuracy rate for data other than data used for learning, that is, generalization performance is as high as possible. However, as described above, by executing morphological analysis, it is possible to execute basic analyzation for a part of speech, a basic structure, and the like of a piece of writing, but it is difficult to highly analyze the piece of writing.

In the techniques disclosed in Patent Literatures 1 and 2, it is possible to execute category classification of restaurant menus, and it is also possible to improve accuracy of the category classification by excluding unnecessary words. However, different category classification may be made each time a menu name is inputted due to so-called over-learning in which artificial intelligence creates an excessively complex model as compared with the amount of possessed information by overfitting the information to data for learning. For that reason, a problem that accuracy of a category to be outputted in response to the inputted menu name of a restaurant is not high occurs.

It is an object of the present disclosure to provide an information processing apparatus, an information processing system, an information processing method, and a program thereof for solving such problems.

### Solution to Problem

An information processing apparatus according to the present disclosure includes: an input unit for inputting a menu name of a restaurant; an output unit for outputting a category name corresponding to the menu name; a storage unit for storing the menu name and the category name corresponding to the menu name so as to be associated with each other; a morphological analysis unit for executing morphological analysis to divide the inputted menu name into words and determine parts of speech; and a specification unit for generating, in a case where no category name corresponding to the inputted menu name is stored in the storage unit, a feature amount vector characterizing whether each of the words is included in the menu name or not as a result of the morphological analysis executed by the morphological analysis unit, and specifying a category name corresponding to the inputted menu name on a basis of a result of learning the menu name and the category name by using the feature amount vector.

An information processing system according to the present disclosure includes: means for inputting a menu name of a restaurant; means for outputting a category name corresponding to the menu name; means for storing the menu name and the category name corresponding to the menu name so as to be associated with each other; means for executing morphological analysis to divide the inputted menu name into words and determine parts of speech; and means for generating, in a case where no category name corresponding to the inputted menu name is stored in the storage means, a feature amount vector characterizing whether each of the words is included in the menu name or not as a result of the morphological analysis, and specifying a category name corresponding to the inputted menu name on a basis of a result of learning the menu name and the category name by using the feature amount vector.

An information processing method according to the present disclosure includes: a step of inputting a menu name of a restaurant; a step of outputting a category name corresponding to the menu name; a step of storing the menu name and the category name corresponding to the menu name so as to be associated with each other; a step of executing morphological analysis to divide the inputted menu name into words and determine parts of speech; and a step of generating, in a case where no category name corresponding to the inputted menu name is stored in storage means, a feature amount vector characterizing whether each of the words is included in the menu name or not as a result of the morphological analysis, and specifying a category name corresponding to the inputted menu name on a basis of a result of learning the menu name and the category name by using the feature amount vector.

A program according to the present disclosure causes an information processing apparatus to execute: a process of inputting a menu name of a restaurant; a process of outputting a category name corresponding to the menu name; a process of storing the menu name and the category name corresponding to the menu name so as to be associated with each other; a process of executing morphological analysis to divide the inputted menu name into words and determine parts of speech; and a process of generating, in a case where no category name corresponding to the inputted menu name is stored in storage means, a feature amount vector characterizing whether each of the words is included in the menu name or not as a result of the morphological analysis, and specifying a category name corresponding to the inputted menu name on a basis of a result of learning the menu name and the category name by using the feature amount vector.

### Advantageous Effects of Invention

According to the present disclosure, there can be provided an information processing apparatus, a system, a method, and a program capable of improving accuracy of a category to be outputted in response to a menu name of an inputted restaurant.

### BRIEF DESCRIPTION OF DRAWINGS

FIG. 1 is a block diagram of an information processing apparatus according to a first example embodiment of the present disclosure.

FIG. 2 is a block diagram of an information processing apparatus according to a second example embodiment of the present disclosure.

FIG. 3 is a flow diagram of a feature extraction process in a morphological analysis unit according to the second example embodiment of the present disclosure.

FIG. 4 is a flow diagram illustrating a practical form of the information processing apparatus according to the second example embodiment of the present disclosure.

### EXAMPLE EMBODIMENTS

Hereinafter, example embodiments will be described with reference to the drawings. Note that since the drawings are drawn in a simplified manner, the technical scope of the example embodiments should not be narrowly interpreted based on the descriptions of the drawings. Further, the same elements are denoted by the same reference numerals or symbols, and redundant descriptions thereof will be omitted.

In the following example embodiments, when necessary, the present disclosure will be explained by using separate sections or separate example embodiments. However, those example embodiments are not unrelated with each other, unless otherwise specified. Namely, they are related in such a manner that one example embodiment is a modified example, an application example, a detailed example, or a supplementary example of a part or the whole of another example embodiment. Further, in the following example embodiments, when the number of elements or the like (including numbers, values, quantities, ranges, and the like) is mentioned, the number is not limited to that specific number except for cases where the number is explicitly specified or the number is obviously limited to a specific number based on its principle. That is, a larger number or a smaller number than the specific number may also be used.

Moreover, in the following example embodiments, their components (including operation steps and the like) are not necessarily indispensable except for cases where the component is explicitly specified or the component is obviously indispensable based on its principle. Similarly, in the following example embodiments, when a shape, a position relation, or the like of a component(s) or the like is mentioned, shapes or the likes that are substantially similar to or resemble that shape are also included in that shape except for cases where it is explicitly specified or they are eliminated based on its principle. This is also true for the above-described number or the like (including numbers, values, quantities, ranges, and the like).

### <Consideration Background Until Information Processing Apparatus According to Example Embodiment was Conceived>

When it is considered that restaurant's own sales are to be increased, it is necessary to refer to which category of menu is sold well at the other restaurants. Here, the category indicates classification by cooking methods, raw materials, birthplaces, or the like of a certain menu. For example, when category names of “meat dishes” and “fish dishes” are prepared, “gyudon (beef bowl)” and “mackerel grilled with salt” are generally classified into categories of a “meat dish” and a “fish dish”, respectively.

However, since even menus in the same category have different menu names depending upon a chain of food services and restaurants, it is difficult to quantitatively compare which category of menu is sold well. For example, it is asked whether each of a menu “set meal of mackerel grilled with salt” offered at restaurant A and a menu “plate of assorted sashimi” offered at restaurant B belongs to a category of “meat dishes” or “fish dishes”, it is possible to determine both of them as “fish dishes” by using human knowledge and human experience. However, there is no mechanical and universal standard for making such determination.

In order to classify texts into certain unified categories, a method of executing natural language processing that combines morphological analysis and artificial intelligence. The morphological analysis divides one piece of writing into a plurality of morphemes, that is, the minimum units each having a meaning in terms of language, determines each part of speech, and extracts dependencies between parts of speech, thereby analyzing the meanings respectively indicated by the pieces of writing. The artificial intelligence learns a large number of pairs of texts of menu names and categories into which they are to be classified, thereby extracting a relationship hidden between them for each category and artificially reproducing human intellectual judgment criteria.

However, when a combination of morphological analysis and artificial intelligence is used in category classification of restaurant menus, there are problems as described below.

A first problem is that general morphological analysis has low accuracy in determining parts of speech of a restaurant menu. According to the general morphological analysis, for example, it is excellent for analysis as “a piece of writing” with a subject, a verb, an object, and the like, such as “Taro gave this book to Hanako.”. However, there are cases where an expected morphological analysis result cannot be obtained because an expression method peculiar to menu names such as “assortment of Italian salami and homemade ham” is not assumed.

A second problem is that artificial intelligence, especially category classification by supervised learning, cannot be classified with accuracy of 100%. In the field of artificial intelligence, neural networks are widely used as high-performance learning model. However, over-learning frequently occurs in which a recognition rate of evaluation data decreases by overfitting data for learning. Further, since suitable hyperparameters are generally searched at random, a situation that data were successfully identified in previous trial, but identification of the data is failed in next trial often occurs. For that reason, even in the category classification of the restaurant menus, it is difficult to correctly identify all menu names existing in the country. In order to trust a classification result by the artificial intelligence, it is necessary that an accuracy rate for data other than data used for learning, that is, generalization performance is as high as possible.

A third problem is that even for the same menu name, category classification may be different depending upon a type of business of a restaurant. Here, the type of business indicates one distinguished by a type of menus that the restaurant mainly sells, such as a “family restaurant” or a “Japanese-style bar”, and a difference of targeted customer bases. For example, considering whether a menu called “fried chicken” belongs to a category of “side menus” or a category of “toppings”, it is classified as the “side menus” in family restaurants, but it is often classified as the “toppings” in curry restaurants. Due to this problem, it can be said that it is difficult to completely link menu names and category names uniquely. It is necessary to flexibly change category systems depending upon not only a difference in types of business but also by which types of classification criteria they are to be analyzed.

From the above description, it is required to apply text mining using morphological analysis and artificial intelligence to menu names of restaurants and classify the menu names into certain unified categories.

Therefore, an information processing apparatus 1 according to the following example embodiment, which is capable of solving such problems, has been found.

### First Example Embodiment

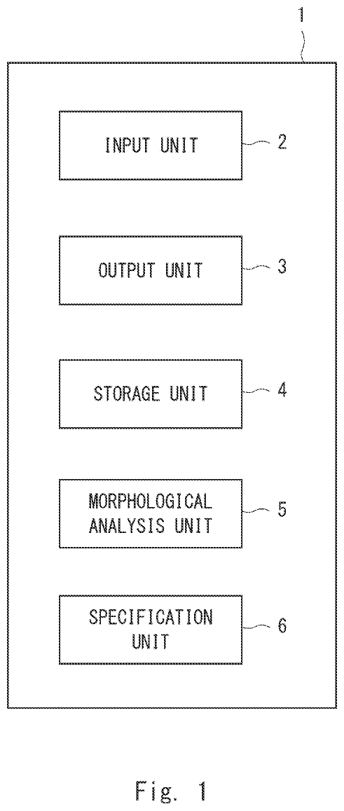

The present example embodiment will be described with reference to FIG. 1. FIG. 1 is a block diagram of an information processing apparatus 1 according to the present example embodiment.

The information processing apparatus 1 according to the present example embodiment includes an input unit 2, an output unit 3, a storage unit 4, a morphological analysis unit 5, and a specification unit 6.

The input unit 2 is configured to input a menu name of a restaurant. The output unit 3 is configured to output a category name corresponding to the menu name. The storage unit 4 is configured to store the menu name of the restaurant and the category name of the menu name so as to be associated with each other.

The morphological analysis unit 5 is configured to execute morphological analysis to divide the menu name inputted by the input unit 2 into words and determine parts of speech. The specification unit 6 is configured to generate, in a case where no category name corresponding to the menu name inputted by the input unit 2 is stored in the storage unit 4, a feature amount vector characterizing whether each of the words is included in the menu name or not as a result of the morphological analysis. The specification unit 6 is also configured to specify a category name corresponding to the inputted menu name on the basis of a result of learning the inputted menu name and the category name by using the feature amount vector.

According to the present example embodiment, it is possible to provide the information processing apparatus 1 capable of improving accuracy of the category name to be outputted in response to the inputted menu name of the restaurant.

### Second Example Embodiment

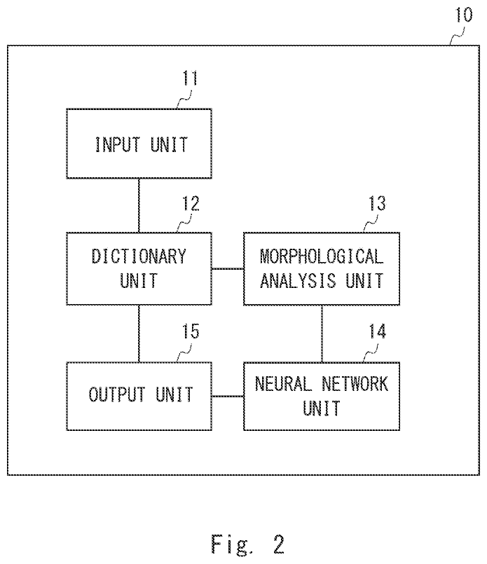

The present example embodiment will be described with reference to FIG. 2. FIG. 2 is a block diagram of an information processing apparatus 10 according to the present example embodiment.

The information processing apparatus 10 according to the present example embodiment includes an input unit 11, a dictionary unit 12, a morphological analysis unit 13, a neural network unit 14, and an output unit 15.

The input unit 11 may be configured by a keyboard, or may be configured by a touch panel display device. The input unit 11 may be configured by a keyboard or a touch panel connected to a body of the information processing apparatus 10.

The dictionary unit 12 can include a nonvolatile memory (for example, a ROM (Read Only Memory)) in which various kinds of programs and various kinds of data required for processing are fixedly stored. Further, the dictionary unit 12 may be one using an HDD or an SSD. Moreover, the dictionary unit 12 can include a volatile memory (for example, a RAM (Random Access Memory)) to be used as a work area. The program described above may be read out from a portable recording medium, such as an optical disc, or a semiconductor memory, or may be downloaded from a server apparatus or the like on a network.

The dictionary unit 12 may store a category name for each type of business to which a location handling a menu corresponding to an inputted menu name belongs. The dictionary unit 12 may register a plurality of categories for respective types of business. Moreover, the dictionary unit 12 may register a pair of a menu name and a category name in a dictionary, and register a plurality of categories in one dictionary. Here, the type of business refers to, for example, family restaurants, Japanese-style bars, and the like, but they are not limited to these.

The morphological analysis unit 13 and the neural network unit 14 may has functions to execute various kinds of controls on the basis of various kinds of programs stored in storage means, and be realized by a central processing unit (CPU), a read-only memory (ROM), a random access memory (RAM), an input/output port (I/O), or the like.

The morphological analysis unit 13 is configured to execute morphological analysis for the inputted menu name. Processes to be executed by the morphological analysis unit 13 will be described later in detail. The neural network unit 14 may include a plurality of neural networks in order to address learning and guess for a common category and a plurality of categories for respective types of business.

When artificial intelligence is caused to learn, learning models for respective types of business are prepared, and are caused to learn only menu names and categories for respective types of business, thereby generating a guess model that is specific to category classification of each of the types of business. When the artificial intelligence is caused to guess, by switching the guess models depending upon the type of business, it is possible to address the category classification based on different criteria.

In this case, according to the method described above, the category name to be classified is unified only in the same type of business. Thus, sales data can be compared only within the same type of business. Therefore, in order to enable sales analysis regardless of types of business, a category system unified for all types of business may be prepared as a common category, and may be registered in the dictionary at the same time of the categories for respective types of business. The common category also prepares learning models as well as the categories for respective types of business. By using the common category, it becomes possible to compare the sales data in all types of business, and this makes it possible to analyze sales regardless of the types of business.

Therefore, the third problem described in <Consideration Background Until Information Processing Apparatus According to Example Embodiment was Conceived>, which is that it is difficult to make completely unique association between menu names and category names, can be solved.

The output unit 15 may be configured by any of various display means, such as an LCD (liquid crystal display), or an LED (light emitting diode). Further, the output unit 15 may be configured so that the content outputted to the output unit 15 is displayed on equipment such as a mobile phone (including so-called smartphones) possessed by a user.

The morphological analysis unit 13 is configured to extract nouns and verbs from a menu name by means of the morphological analysis, and exclude specific nouns that are not directly related to classification therefrom. Namely, the morphological analysis unit 13 extracts nouns and verbs as parts of speech in the morphological analysis. This is because parts of speech each playing the most important role in category classification of menus are partial nouns each of which most expresses a feature of a menu. Further, this is because verbs, such as “grilled ˜” and “boiled ˜”, whose conjunctive forms indicate cooking methods, also play an important role in the category classification of menus.

Since adjectives and adjective verbs are merely modifications of nouns, the morphological analysis unit 13 excludes them. Further, since postpositional particles are attached words and merely play a role to connect words, the postpositional particle are to be excluded. Moreover, among nouns, specific words that are not related to category classification of menu names of restaurants exist. In a case where such specific words are included in menu names of different categories, it leads to deterioration of classification performance in the artificial intelligence. For that reason, the specific words are listed up, and are excluded from the extracted nouns. By excluding the specific words, the morphological analysis specialized for the category classification of the restaurant menus can be realized.

The morphological analysis unit 13 is configured to exclude adjective verbs recognized as nouns as specific words. For example, in case of “premium gyudon” generally regarded as a “Japanese food”, two words of “premium” and “gyudon” may be extracted as nouns as a result of the morphological analysis. The “premium” mentioned herein is not exactly a noun, but is one obtained by removing Japanese “na” from an attributive form “premium na” of an adjective verb. Namely, the “premium” is merely a modification of the noun “gyudon”, and is not suitable for a feature of words constituting a specific category. For example, since the “premium” has the same feature as that of “premium steak” generally regarded as a “western food”, the distinction between the “Japanese food” and the “western food” becomes unclear. Therefore, by excluding the “premium” as the specific words at the stage of the morphological analysis and limiting the features to the “gyudon” and the “steak”, it is easy to execute the category classification.

The specific words to be excluded by the morphological analysis unit 13, which are adjective verbs recognized as the nouns, are as follows, for example, but they are not limited to these. Namely, for example, “luxurious”, “premium”, “mini”, “petit”, “mega”, and the like correspond to these.

The morphological analysis unit 13 is configured to exclude modifiers, which are recognized as nouns, as specific words. For example, when the morphological analysis is executed for “heaping French fries”, two nouns of “heaping” and “French fries” are extracted. Here, the “heaping” is one obtained by removing Japanese “no” from “heaping no”. As well as the adjective verb, the “heaping” is merely a modification of the noun “French fries”.

As the specific words to be excluded by the morphological analysis unit 13, which are modifiers recognized as the nouns, “handmade”, “special”, “homemade”, “limited”, “carefully selected”, “domestically produced”, “vaunted”, “excellent”, “mystic”, “specialty”, “direct from the farm”, “seriously delicious”, “hot”, “grainy”, “recommended”, “fussy”, “freshly cooked”, “freshly picked”, “freshly fried”, “finely sliced”, “thinly sliced”, “thickly sliced”, “heaping”, “filled”, and the like may be cited, but they are not limited to these.

The morphological analysis unit 13 is configured to exclude, as the specific words, words that correspond to “how to sell a product” recognized as nouns. This is because a form of “how to sell a product” is often unrelated to the classification. As the words to be excluded as the specific words by the morphological analysis unit 13, which correspond to “how to sell a product” recognized as nouns, “single”, “free”, “tax included”, “tax excluded”, “every kind”, “large”, “medium”, “small”, “half”, “size”, “assorted”, and the like may be cited, but they are not limited to these.

As described above, the morphological analysis unit 13 excludes the specific words, and the morphological analysis is then executed, whereby the first problem described in <Consideration Background Until Information Processing Apparatus According to Example Embodiment was Conceived>, which is that accuracy of determination of a part of speech of a restaurant menu, can be solved.

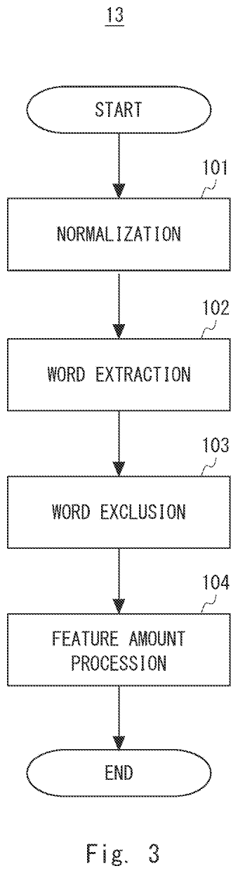

Here, a feature extraction process executed by the morphological analysis unit 13 will be described with reference to FIG. 3. FIG. 3 is a flow diagram illustrating a flow of the feature extraction process in the morphological analysis unit 13.

In a normalization process (Step 101), a difference between formats of characters, such as half-width katakana characters and full-width alphanumeric characters, is uniformed. In a word extraction process (Step 102), morphological analysis is executed, whereby only words each determined as a noun or a verb are extracted. Note that Japanese fluctuations such as Chinese character (Kanji), Hiragana, and kana added after a Chinese character are normalized herein. In a word exclusion process (Step 103), unnecessary words are excluded from the extracted words.

For example, the specific words to be excluded in the word exclusion process are as follows. Namely, there are “luxurious”, “premium”, “mini”, “petit”, “mega”, “handmade”, “special”, “homemade”, “limited”, “carefully selected”, “domestically produced”, “vaunted”, “excellent”, “mystic”, “specialty”, “direct from the farm”, “seriously delicious”, “hot”, “grainy”, “recommended”, “fussy”, “freshly cooked”, “freshly picked”, “freshly fried”, “finely sliced”, “thinly sliced”, “thickly sliced”, “heaping”, “filled”, “single” “free”, “tax included”, “tax excluded”, “every kind”, “large”, “medium”, “small”, “half”, “size”, “assorted”, and the like, but they are not limited to these.

In a feature amount procession process (Step 104), each of the words is set to a feature amount. A multidimensional vector may be generated so as to have 1 in a case where each of the words is included, or 0 in a case where each of the words is not included. This multidimensional vector becomes an input signal to the neural network unit 14.

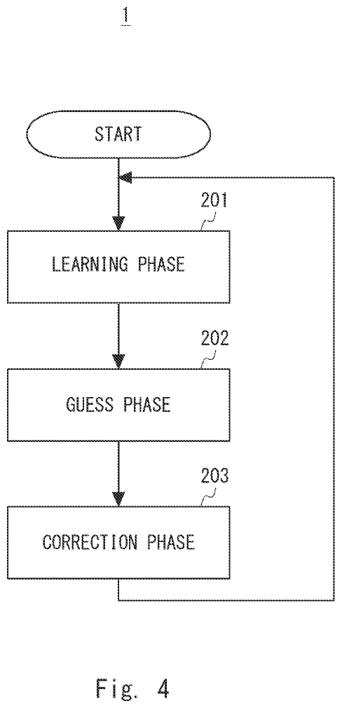

Next, an example of a practical form of the information processing apparatus 10 according to the present example embodiment will be described with reference to FIG. 4. In the operation of the information processing apparatus 10, a learning phase (Step 201), a guess phase (Step 202), and a correction phase (Step 203) are included. By rotating these phases, the present disclosure can be realized.

The learning phase (Step 201) executed by the information processing apparatus 10 will first be described. In the learning phase, a module of the dictionary unit 12, the morphological analysis unit 13, and the neural network unit 14 is utilized.

Each of menu names registered in the dictionary unit 12 is inputted to the morphological analysis unit 13. The morphological analysis unit 13 executes preprocessing in accordance with the flow of FIG. 3. The menu name after preprocessing is used as an input signal to the neural network unit 14, and a pair of it and each of category names registered in the dictionary unit 12 is learned. Here, learning models of a neural network is switched in accordance with a difference between a common category and a category for each type of business to constitute a guess model corresponding to each category system. It is preferable that learning algorism uses a supervised learning method.

Next, details about the guess phase (Step 202) will be described. In the guess phase, the input unit 11, the dictionary unit 12, the morphological analysis unit 13, the neural network unit 14, and the output unit 15 are utilized.

The input unit 11 transfers a menu name with a text form to the dictionary unit 12. A subsequent process branches depending upon whether the menu name has already been registered in the dictionary unit 12 or not. In a case where the menu name has already been registered, the dictionary unit 12 obtains a category name corresponding to the menu name, and causes the output unit 15 to output a category. In a case where the menu name has not been registered yet, the dictionary unit 12 transfers the menu name to the morphological analysis unit 13.

The morphological analysis unit 13 executes preprocessing in accordance with the flow of FIG. 3. For the menu name after the preprocessing, a category name is guessed by using a guess model for each category system constituted in the learning phase. The guessed category name is outputted by the output unit 15.

Finally, details about the correction phase (Step 203) will be described. In the correction phase, the dictionary unit 12 is utilized.

In the correction phase, among the category names guessed in the guess phase by using the guess models, incorrect category name(s) are corrected by a user. The category name(s) after correction are re-registered in the dictionary unit 12 as fixed category names. The re-registered menu names are used as data for learning in the learning phase.

As described above, the information processing apparatus 10 according to the present example embodiment includes the dictionary unit 12 in which the menu name and the category name are stored so as to be associated with each other. If the category name guessed by the artificial intelligence is incorrect, the user can correct it via the input unit 11. The category name after correction is stored in the dictionary unit 12 so as to be associated with the menu name. Then, the dictionary unit 12 is searched before the artificial intelligence is caused to guess a category. In a case where a matching menu name is found, the category name is outputted from the output unit 15. In a case where there is no matching menu name in the dictionary unit 12, guess of the category name by the artificial intelligence is executed.

For that reason, it is possible to output a reliable category name for the menu name similar to that of the menu that has previously been learned. Namely, even though the learning model is re-learned during the operation thereof, the menu name, which has been stored so as to be associated with a correct category name once, is guessed accurately.

By repeating the processes described above, data in which there is no difference in association between menu names and category names are accumulated in the dictionary unit 12, whereby the accuracy of the learning model of the artificial intelligence gradually improves. Namely, the more the information processing apparatus 10 continues the operation through the cycle of the learning phase, the guess phase, and the correction phase, the more determination accuracy of the category name improves. Therefore, the second problem described in <Consideration Background Until Information Processing Apparatus According to Example Embodiment was Conceived>, which is that it is necessary to improve accuracy of the category classification by the artificial intelligence, especially the supervised learning, can be solved.

According to the present example embodiment, by classifying menu names of restaurants into certain unified category names by means of a category classification method for restaurant menus based on the morphological analysis and the artificial intelligence, it becomes possible to quantitatively compare sales data and the like for respective categories between different restaurants.

### Another Example Embodiment

The information processing apparatus 1 according to the present disclosure an example embodiment as an information processing method, for example. Namely, the information processing method includes: a step of inputting a menu name of a restaurant; a step of outputting a category name corresponding to the menu name; a step of storing the menu name and the category name corresponding to the menu name so as to be associated with each other; a step of executing morphological analysis to divide the inputted menu name into words and determine parts of speech; and a step of generating, in a case where no category name corresponding to the inputted menu name is stored in the storage unit, a feature amount vector characterizing whether each of the words is included in the menu name or not as a result of the morphological analysis, and specifying a category name corresponding to the inputted menu name on a basis of a result of learning the menu name and the category name by using the feature amount vector.

In the example described above, programs can be stored using various types of non-transitory computer readable mediums (non-transitory computer readable medium), and be supplied to a computer. The non-transitory computer readable mediums include various types of tangible recording mediums (tangible storage mediums). The non-transitory computer readable mediums include magnetic recording mediums, magneto-optical recording mediums, CD-ROMs, CD-Rs, CD-R/Ws, semiconductor memories, for example. The semiconductor memories are, for example, mask ROMs, PROMs (Programmable ROMs), EPROMs (Erasable PROMs), flash ROMs, RAMs, and the like. Further, the programs may be provided to the computer by various types of transitory computer readable mediums (transitory computer readable mediums). Examples of the transitory computer readable mediums include electrical signals, optical signals, and electromagnetic wave. The transitory computer readable mediums can supply the programs to the computer via wired communication paths such as electrical wires and optical fibers, or wireless communication paths.

The program described above is a program causing the information processing apparatus 1 to execute: a process of inputting a menu name of a restaurant; a process of outputting a category name corresponding to the menu name; a process of storing the menu name and the category name corresponding to the menu name so as to be associated with each other; a process of executing morphological analysis to divide the inputted menu name into words and determine parts of speech; and a process of generating, in a case where no category name corresponding to the inputted menu name is stored in storage means, a feature amount vector characterizing whether each of the words is included in the menu name or not as a result of the morphological analysis, and specifying a category name corresponding to the inputted menu name on a basis of a result of learning the menu name and the category name by using the feature amount vector.

Note that, the present disclosure is not limited to the example embodiments described above, and can be modified as appropriate without departing from the spirit and scope of the present disclosure.

This application is based upon and claims the benefit of priority from Japanese Patent Application No. 2020-217153, filed on Dec. 24, 2020, and the disclosure of which is incorporated herein in its entirety by reference.

### REFERENCE SIGNS LIST

1, 10 INFORMATION PROCESSING APPARATUS
2, 11 INPUT UNIT
3, 15 OUTPUT UNIT
4 STORAGE UNIT
5, 13 MORPHOLOGICAL ANALYSIS UNIT
6 SPECIFICATION UNIT
12 DICTIONARY UNIT
14 NEURAL NETWORK UNIT

What is claimed is:

1. An information processing apparatus comprising:
a memory storing instructions; and
a processor configured to execute the instructions to:
input a menu name of a restaurant;
output a category name corresponding to the menu name;
store the menu name and the category name corresponding to the menu name in the memory so as to be associated with each other;
execute morphological analysis to divide the inputted menu name into words and determine parts of speech; and
generate, in a case where no category name corresponding to the inputted menu name is stored in the memory, a feature amount vector characterizing whether each of the words is included in the menu name or not as a result of the executed morphological analysis, and specifying a category name corresponding to the inputted menu name on a basis of a result of learning the menu name and the category name by using the feature amount vector.

2. The information processing apparatus according to claim 1, wherein the processor is further configured to execute the instructions to specify that the category name corresponds to the inputted menu name in a case where the category name corresponding to the inputted menu name is stored in the memory.

3. The information processing apparatus according to claim 1, wherein the processor is further configured to execute the instructions to extract nouns and verbs from the words obtained by dividing the inputted menu name and exclude specific words from the extracted nouns to execute the morphological analysis.

4. The information processing apparatus according to claim 1, wherein the processor is further configured to execute the instructions to store the category name for each type of business to which a location handling a menu corresponding to the inputted menu name belongs.

5. The information processing apparatus according to claim 1, wherein the processor is configured to execute the instructions to specify the category name corresponding to the inputted menu name by means of a supervised learning method.

6. (canceled)

7. An information processing method comprising:
inputting a menu name of a restaurant;
outputting a category name corresponding to the menu name;
storing the menu name and the category name corresponding to the menu name so as to be associated with each other;
executing morphological analysis to divide the inputted menu name into words and determine parts of speech; and
generating, in a case where no category name corresponding to the inputted menu name is stored in a storage, a feature amount vector characterizing whether each of the words is included in the menu name or not as a result of the morphological analysis, and specifying a category name corresponding to the inputted menu name on a basis of a result of learning the menu name and the category name by using the feature amount vector.

8. A non-transitory computer readable medium in which a program is stored, the program causing an information processing apparatus to execute:
inputting a menu name of a restaurant;
outputting a category name corresponding to the menu name;
storing the menu name and the category name corresponding to the menu name so as to be associated with each other;
executing morphological analysis to divide the inputted menu name into words and determine parts of speech; and
generating, in a case where no category name corresponding to the inputted menu name is stored in a storage, a feature amount vector characterizing whether each of the words is included in the menu name or not as a result of the morphological analysis, and specifying a category name corresponding to the inputted menu name on a basis of a result of learning the menu name and the category name by using the feature amount vector.
